(19) United States
(12) Patent Application Publication
(10) Pub. No.: US 2006/0152169 A1
(43) Pub. Date: Jul. 13, 2006

(54) Electronic circuit for supplying a high-pressure discharge arc lamp

(75) Inventor: Peter Lurkens, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/524,657

(22) PCT Filed: Aug. 13, 2003
(86) PCT No.: PCT/IB03/03697

§ 371 Date: Feb. 17, 2005

(30) Foreign Application Priority Data
Aug. 22, 2002 (DE) 102 38 373.1

(51) Int. Cl. H05B 37/00; H05B 39/00

(52) U.S. Cl. 315/244

(57) ABSTRACT

The invention relates to an electronic circuit and to a method of supplying a high-pressure discharge arc lamp (12). The circuit comprises a DC-AC converter, for which purpose two controllable switching elements T1, T2 are connected in the form of a half bridge to an operating potential U+ and a reference potential (10). The circuit further comprises a two-stage filter arrangement. The lamp is connected to a coil Lign of the second filter stage, and the same connection terminal of this coil L_{ign} is connected to the reference potential (10) via a capacitor C_{ign}. To make the circuit as small and as economical as possible, while high high-frequency interference peaks and strong currents in the circuit are avoided, it is proposed that a coil Tr_{filt} of the first filter stage has at least three taps. The first, outer tap is connected to the output of the half bridge, the second, central tap to the second connection terminal of the coil L_{ign}, and the third, outer tap to the reference potential (10) via a capacitor C_{filt}.

The invention relates to an electronic circuit for supplying a high-pressure discharge arc lamp and to methods of operating a high-pressure discharge arc lamp with such an electronic circuit.

High-pressure discharge arc lamps are used, for example, in modern data and video projectors. They have a very high power and are characterized by a particularly short discharge arc. It is possible on the basis of optical laws to manufacture projectors with such lamps and with small optical systems, which nevertheless have a high luminous efficacy, i.e. produce a bright image. This has led to a considerable reduction in size and also in cost of the projectors.

At the same time, however, new requirements have arisen as to the dimensions and cost of the electronic components in such a projector. An essential electronic component here is the electronic supply circuit, also denoted ballast, for the high-pressure discharge arc lamp.

The supply circuit has the task first of all of generating a voltage in a range of several kilovolts for a short period for igniting the lamp, which is necessary to initiate the arc discharge. During subsequent operation, the supply circuit has the task of controlling the current through the lamp such that a constant average power adjusts itself in the lamp. A particular feature here is that high-pressure arc discharge lamps generally have a negative current-voltage characteristic which requires a supply circuit capable of supplying a limited current. The current through the lamp can be kept constant with considerable difficulties only in the case of voltage-limiting circuits. It is furthermore usual to operate high-pressure discharge arc lamps with a low-frequency square-wave alternating current. This allows for a more even load on the lamp electrodes than in the case of a direct current supply, as well as a constant, flicker-free lamp brightness.

Various electronic circuits for supplying a high-pressure discharge arc lamp are known in the art. These circuits usually comprise a DC-AC converter bridge circuit which is supplied with a constant DC voltage and which provides a low-frequency alternating current at its output.

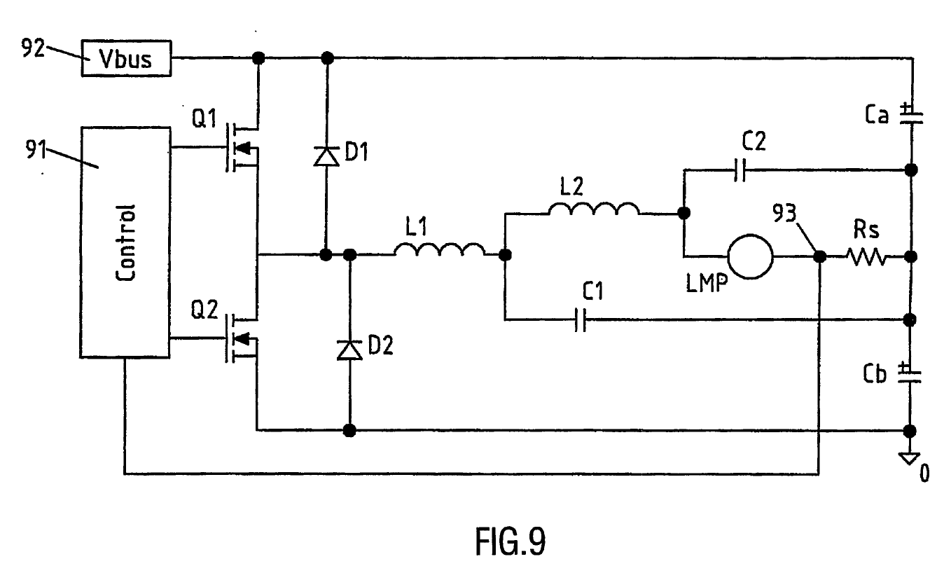

A supply circuit that manages to operate with a particularly small number of power components is described in the publication U.S. Pat. No. 6,020,691. The small number of power components is achieved in that the circuit uses a DC-AC converter in the form of a half bridge circuit. This circuit is shown in FIG. 9.

The circuit comprises a half bridge which has a transistor Q1, Q2 in each of its two bridge branches. To control the transistors Q1, Q2, a control device 91 is provided. The half bridge is connected at one side to a DC voltage source via a terminal Vbus 92 and at the other side to a reference potential 0 for the purpose of supplying the circuit. The control device 91 controls the transistors Q1, Q2 such that an AC current is made available at the output of the half bridge, i.e. between the two transistors Q1, Q2. Each of the transistors Q1, Q2 has a diode D1, D2 connected in parallel thereto, which diode is conducting in a direction from the reference potential to the supply voltage. Two capacitors Ca, Cb arranged in series are connected parallel to the entire half bridge, also between the supply voltage and the reference potential. These capacitors Ca, Cb replace the second half bridge in the otherwise often implemented DC-AC converter comprising a full bridge circuit.

A two-stage low-pass filter is connected between the output of the half bridge and the junction point between the two capacitors Ca, Cb. The first filter stage of the two-stage low-pass filter is designed to reduce high-frequency interferences during normal operation, whereas the second filter stage mainly serves to generate a high-frequency ignition voltage. The first filter stage for this purpose comprises a first coil L1 and a third capacitor C1, and the second filter stage comprises a second coil L2 and a fourth capacitor C2. The first terminal of the coil L1 is connected to the output of the half bridge here. The second terminal of the coil L1 is connected via the capacitor C1 to the junction point between the two capacitors Ca, Cb. Furthermore, the second terminal of the coil L1 is connected to the first terminal of the coil L2. The second terminal of the coil L2 is also connected to the junction point between the two capacitors Ca, Cb, on the one hand via the capacitor C2, and on the other hand via a series arrangement of a high-pressure discharge arc lamp LMP and a resistor Rs. The second filter stage comprising the coil L2 and the capacitor C2 preferably has a higher resonance frequency than the first filter stage comprising the coil L1 and the capacitor C1. The two capacitors Ca, Cb must be dimensioned sufficiently large so as to be capable of accommodating the low-frequency component of the lamp current without too high voltage fluctuations.

A current sensor 93 senses the current between the lamp LMP and the resistor Rs and supplies it as a parameter to the control device 91.

To obtain the high voltage necessary for igniting the lamp, the resonant circuit formed by the second coil L2 and the second capacitor C2 is excited by a suitable control of the circuit by the control device 91. Extremely high currents arise in the circuit as a result of this, which may be of the order of ten times the normal lamp current, if an ignition voltage in the kilovolt range is to be generated. This means that the coil L2 must be constructed such that it is not saturated at these currents. If the second filter stage L2, C2 has a higher resonance frequency than the first filter stage L1, C1, moreover, it is only the already strongly attenuated AC voltage of the half bridge Q1, Q2 that is available for exciting the resonance. This attenuated AC voltage requires a particularly high quality factor of the tuned circuit L2, C2, to which is linked a correspondingly high expenditure in providing the components. Furthermore, the simultaneous requirements of a high voltage and a low AC component in the lamp during normal operation lead to the occurrence of comparatively high currents in the circuit. Finally, the arrangement described of coils and capacitors may lead to high high-frequency interference peaks at least during the ignition phase.

The invention has for its object to develop the electronic circuit for supplying a high-pressure discharge arc lamp as shown in FIG. 9 further such that the described disadvantages can be avoided without detracting from the existing advantages. The invention in particular has for its object to provide as small and as economical an electronic circuit as possible for supplying a high-pressure discharge arc lamp in which the high high-frequency interference peak and strong currents in the circuit are avoided.

This object is achieved by an electronic circuit as claimed in claim 1.

The invention has the particular feature that the first filter stage of the two-stage filter has a coil with three taps instead of a coil with two end terminals. The coil of the second filter stage is connected to the central tap of the coil having the three taps, while the outer terminals of the coil are again connected to the output of the half bridge on the one side, and on the other side to the reference potential of the circuit via a capacitor. It is possible with such an embodiment to provide different functions of the coil for different operational modes of the circuit.

In principle, the combination of the coil with three taps and the capacitor connected to this coil represents a serial tuned circuit. If such a tuned circuit is operated above its resonance frequency, the voltage gradient across the capacitor is in counter phase to the voltage gradient at the input of the tuned circuit. The tapped coil may now be regarded as a kind of inductive voltage divider at whose central tap a superimposed value of the voltages at the two ends can be taken off. If the two voltages are in counter phase, it is achieved through a correct choice of the ratio of the two partial windings that the two voltages cancel each other out. The arrangement of the coil with three taps and the capacitor connected to this coil thus performs the function of a blocking filter for a certain, exactly defined blocking frequency.

It is accordingly an advantage of the invention that each and every high-frequency component can be suppressed in the lamp for a selectable blocking frequency.

At the same time, the coil with three taps merely operates as a voltage divider without blocking action for all other frequencies. If the operational frequency, moreover, is considerably higher than the blocking frequency, there will be no strong attenuation or damping of the output signal of the half bridge owing to the filter action of the first filter stage. This makes it possible to choose the quality factor of the tuned circuit of the second filter stage to be lower than in the known half bridge circuit, without losing the voltage increase necessary for ignition.

Since the combination of the coil with three taps and the connected capacitor has a blocking filter action, the capacitor of the first filter stage can be dimensioned considerably smaller than in a conventional circuit if at the same time the switching frequency of the half bridge is identical to the blocking frequency of the filter.

Advantageous embodiments of the invention are apparent from the dependent claims.

The dimensioning of the central tap of the coil with three taps and of the capacitor connected to this coil is of particular importance here. The two components are preferably dimensioned such that the frequency component at the output of the half bridge, which is dominant during normal operation of the lamp, is extinguished at the central tap of the coil with three taps. The voltage at the output of the half bridge does comprise multiples of this dominant frequency which are not suppressed. However, an effective filter is available for said multiples in the further coil, because the interfering frequencies are higher by integer multiples. It is thus possible to obtain the particularly complicated filtering of the base frequency of the switch mode power supply by means of particularly small components.

The second filter stage, however, is preferably dimensioned such that its resonance frequency lies well above the blocking frequency of the first filter stage. Lamp ignition is made possible thereby during operation of the circuit at this frequency without the excitation signal being strongly damped and without an extremely high current being generated through the filter components.

Further advantageous embodiments and advantages of the invention are given in the ensuing description of embodiments of the electronic circuit according to the invention, with:

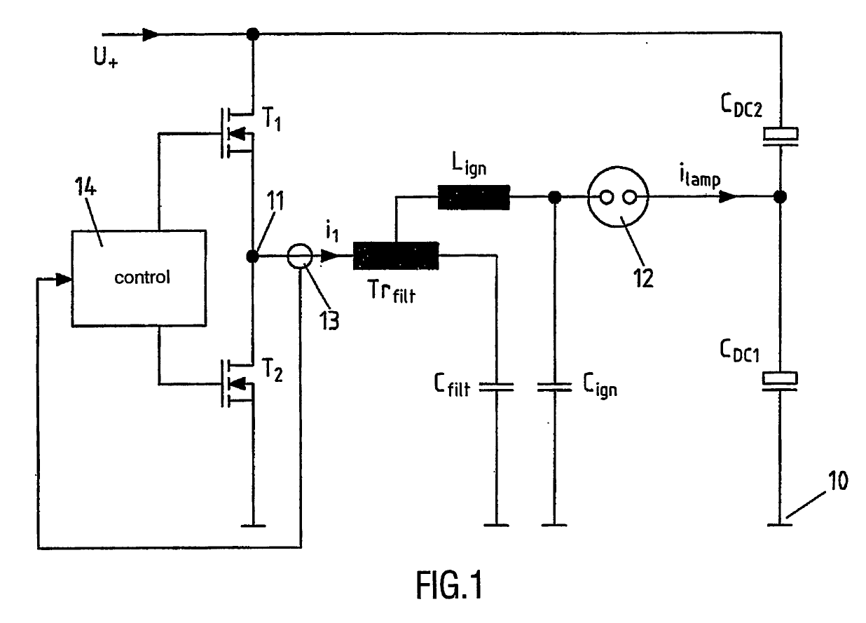

FIG. 1 showing a first embodiment of the electronic circuit according to the invention,

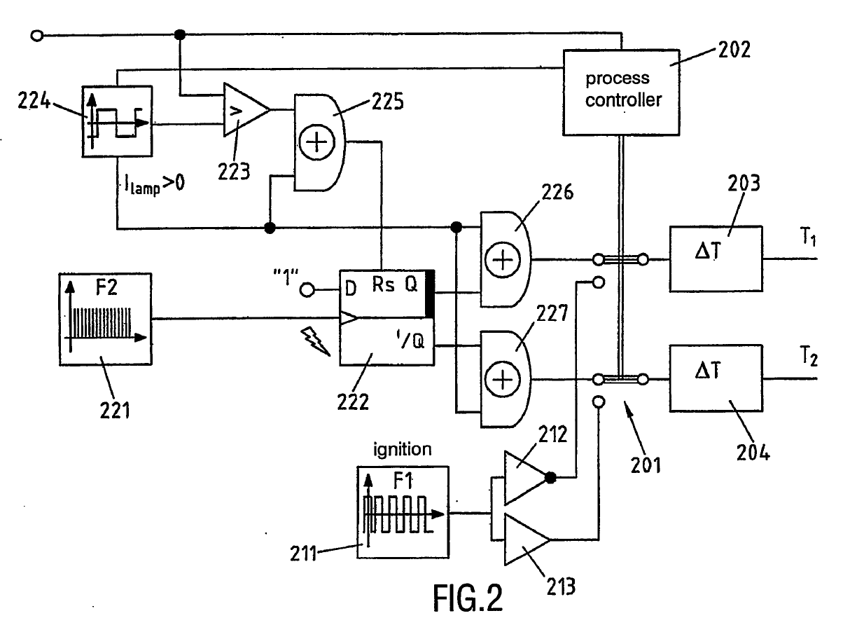

FIG. 2 being a diagram of an embodiment of the control circuit of the circuit of FIG. 1,

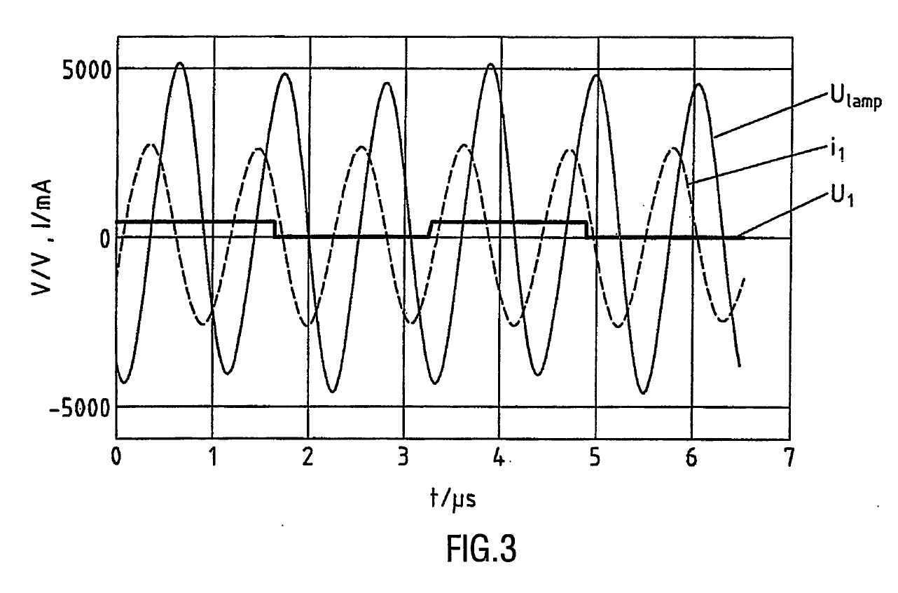

FIG. 3 showing examples of current and voltage gradients in the circuit of FIG. 1 during an ignition phase,

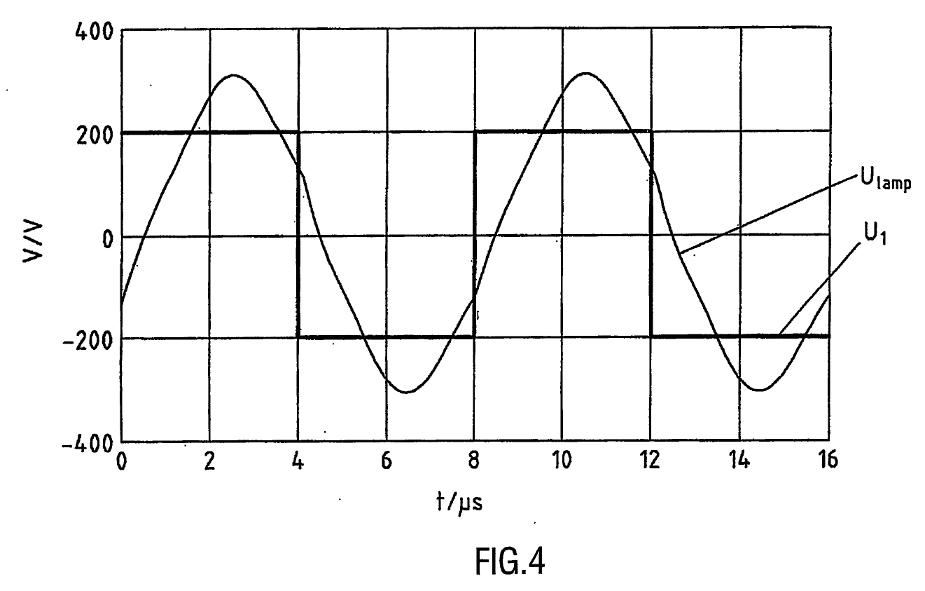

FIG. 4 showing examples of voltage gradients in the circuit of FIG. 1 during a heating-up phase,

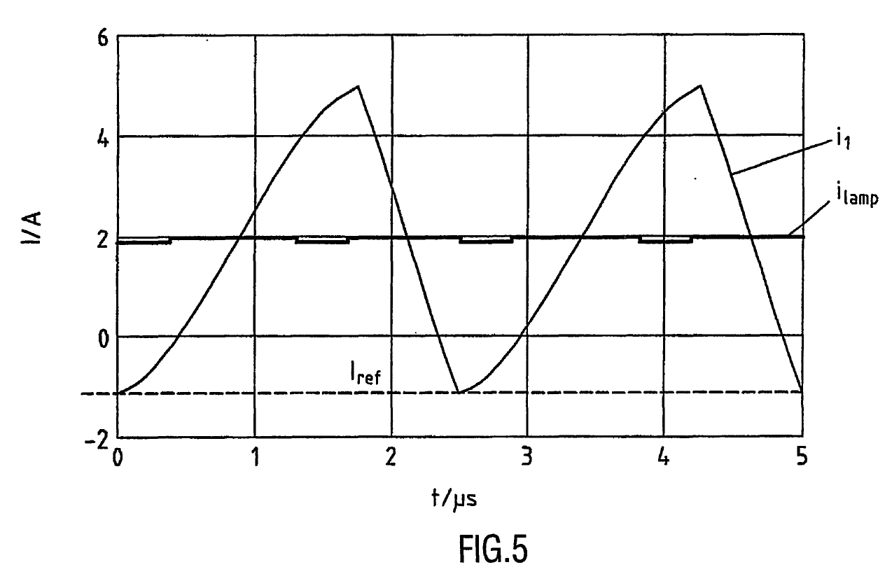

FIG. 5 showing examples of current gradients in the circuit of FIG. 1 during normal operation,

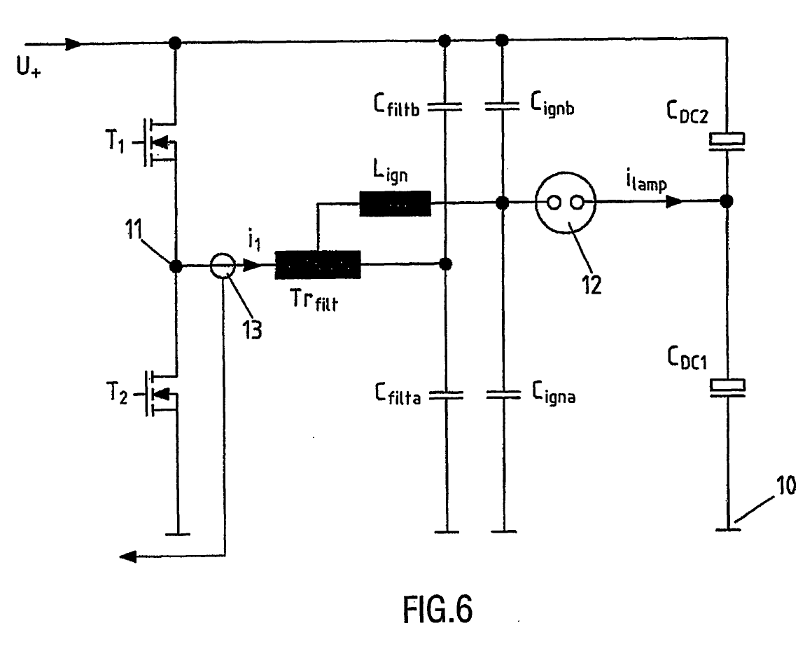

FIG. 6 showing a second embodiment of the electronic circuit according to the invention,

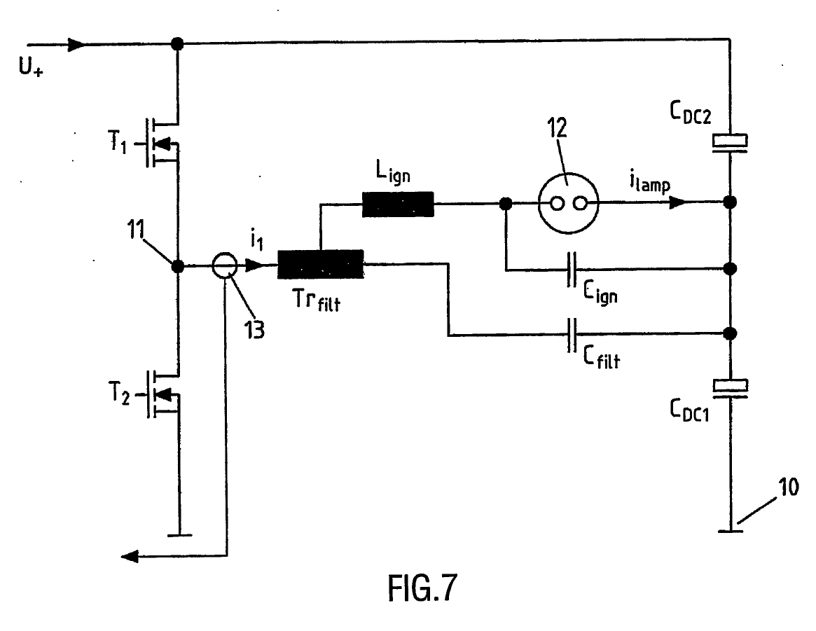

FIG. 7 showing a third embodiment of the electronic circuit according to the invention,

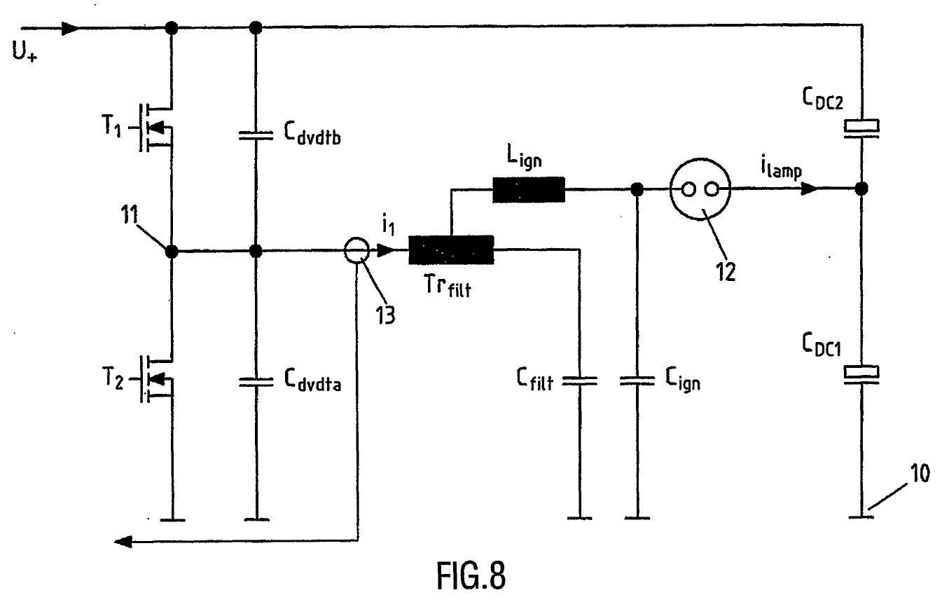

FIG. 8 showing a fourth embodiment of the electronic circuit according to the invention, and

FIG. 9 showing an electronic circuit for supplying high-pressure discharge lamps from the prior art.

FIG. 1 shows a first embodiment of the electronic circuit according to the invention.

It comprises two power transistors T_{1 and T}₂ which are connected to a supply voltage U₊ and to the reference potential 10 of the circuit in the manner of a half bridge. A series arrangement of two electrolytic capacitors C_{DC2}, C_{DC1} is connected in parallel to the entire half bridge between the supply voltage U₊ and the reference potential 10 of the circuit. A coil Tr_{filt} with three taps is connected by its first terminal to the output 11 of the half bridge. The central tap of the coil Tr_{filt} is connected to the first terminal of a second coil L_{ign}. The remaining third, outer tap or terminal of the coil Tr_{filt} is connected via a capacitor C_{filt} directly to the reference potential 10 of the circuit. The coil Tr_{filt} and the capacitor C_{filt} are dimensioned such that the frequency component at the output 11 of the half bridge which is dominant during normal operation of the circuit is extinguished at the central tap of the coil Tr_{filt}, i.e. it forms a blocking frequency.

The second terminal of the coil L_{ign} is connected to a further capacitor C_{ign} having the reference potential 10 of the circuit. Furthermore, the second terminal of the coil L_{ign} is connected to a first terminal for a high-pressure discharge arc lamp 12. The second terminal of the high-pressure discharge arc lamp 12 is connected to the junction point between the two capacitors C_{DC1} and C_{DC2}. The coil L_{ign} and the capacitor C_{ign} are dimensioned such that they form a tuned circuit having a resonance frequency which lies above the blocking frequency mentioned above.

A current sensor 13 which senses the current i₁ through the coil Tr_{filt} is furthermore provided between the output 11 of the half bridge and the first terminal of the coil Tr_{filt}. The value measured by the current sensor 13 is supplied to a control circuit 14 which switches the transistors T_{1 and T}₂ of the half bridge on and off in alternation in dependence on the received value such that a desired current gradient is achieved in the lamp 12.

FIG. 2 shows a possible embodiment of a suitable control circuit 14 for driving the transistors T₁, T₂ of the half bridge shown in FIG. 1.

The control circuit comprises, first of all for lamp ignition, a first frequency generator 211 which generates a high-frequency signal having a frequency F1 and delivers it to a multiplexer 201 via two complementary outputs 212, 213. The frequency F1 here corresponds substantially to the resonance frequency of the ignition circuit formed by the coil L_{ign} and the capacitor C_{ign} of the circuit shown in FIG. 1.

For normal lamp operation, moreover, the control circuit comprises a second frequency generator 221 which generates pulses having a frequency F2, which pulses set a flipflop 222 each time. The frequency F2 forms the dominant frequency component at the output of the half bridge during normal operation of the circuit.

The measured value of the current i₁ supplied by the current sensors 13 of FIG. 1 is also fed to a comparator 223, while the second input of the comparator 223 is fed from a low-frequency waveform generator 224. The signal from the waveform generator 224 here represents the desired lamp current gradient. The output of the comparator 223 and a further signal of the waveform generator 224, this latter signal indicating the instantaneously desired current direction in the lamp 12 as a polarity signal, are supplied to an EXCLUSIVE-OR member 225. A desired positive lamp current leads to the generation of a high-level polarity signal “1” by the waveform generator 224 and accordingly to an inversion of the comparator output by the EXCLUSIVE-OR member 225. The output of the EXCLUSIVE-OR member 225 is connected to a reset input of the flipflop 222. A high-level output signal “1” of the EXCLUSIE-OR member 225 achieves a reset of the flipflop 222 each time.

The flipflop 222 supplies two complementary output signals Q and /Q. The two output signals are supplied, each via a respective EXCLUSIVE-OR member 226, 227, also to the multiplexer 201. The second input signal of the two EXCLUSIVE-OR members 226, 227 again is the polarity signal of the waveform generator 224. A process controller 202 switches the multiplexer 201 in dependence on the measured current i₁ either to the complementary outputs of the second frequency generator 211 or to the complementary outputs of the EXCLUSIVE-OR members 226, 227. The signal pair selected at any time is then supplied by the multiplexer 201 via a respective delay stage 203, 204 to the control terminals of the power transistors T_{1 and T}₂.

The supply of a high-pressure discharge lamp 12 by means of the circuit shown in FIGS. 1 and 2 will now be described below.

In the non-ignited state, the high-pressure discharge lamp 12 is to be regarded as an interruption. This means that the current in the coil L_{ign} can only flow away through the capacitor C_{ign}. As a result, the coil L_{ign} is supplemented by the capacitor C_{ign} so as to form a series resonant circuit. Now when the half bridge is operated at the resonance frequency of this series resonant circuit, a high voltage will build up in the resonant circuit L_{ign}, C_{ign}. If the resonance frequency of the resonant circuit L_{ign}, C_{ign} is unequal to the blocking frequency of the filter formed by the coil Tr_{fit} and the capacitor C_{filt}, an excitation of the resonant circuit L_{ign}, C_{ign} can still take place because the inductive voltage divider formed by the coil Tr_{filt} is not attuned. If the resonance frequency of the resonant circuit L_{ign}, C_{ign} is considerably higher than the blocking frequency, the voltage across the capacitor C_{filt} may be regarded as constant by approximation. The residual voltage at the central tap of the coil Tr_{filt} in this case corresponds to the winding ratio of the coil Tr_{filt}. This now makes it possible to utilize any desired high frequencies for exciting the ignition circuit L_{ign}, C_{ign} without the excitation signal being too strongly damped by the filter action of the first filter stage Tr_{filt}, C_{filt}.

When the process controller 202 recognizes from the measured values of the current i₁ obtained from the current sensor 13 that no low-frequency current flows through the coil Tr_{filt} at the moment, it is concluded that the lamp 12 is not operating. The process controller 202 then switches the complementary outputs 212, 213 of the first frequency generator 211 directly to the delay stages 203, 204 for the purpose of ignition of the lamp 12. The resonance frequency of the ignition circuit L_{ign}, C_{ign} is excited thereby in the circuit, which in its turn generates a sufficiently high voltage for igniting the lamp 12, of the order of several kilovolts. At the same time, the output current i₂ of the half bridge remains comparatively low because of the transformer function of the coil Tr_{filt}. The coil L_{ign} has a limiting effect on the lamp current iₗₐₘₚ at the adjusted high resonance frequency of the ignition circuit L_{ign}, C_{ign}.

A particularly advantageous situation arises when the resonance frequency of the ignition circuit L_{ign}, C_{ign} is exactly three times the blocking frequency of the first filter stage Tr_{filt}, C_{filt}. It is possible then to excite the ignition circuit L_{ign}, C_{ign} by means of the third harmonic of the square-wave gradient of the voltage U₁ at the output 11 of the half bridge. This results in current amplitudes i₁ in the components of the circuit which are no greater than during normal operation if said circuit is optimized with the smallest possible components for maintaining usual current waveforms during normal operation. FIG. 3 shows a relevant square-wave gradient of the voltage U₁ at the output of the half bridge in volts, a relevant gradient of the voltage Uₗₐₘₚ across the lamp with the threefold frequency in volts, and a relevant gradient of the output current i₁ of the half bridge in milliamps as a function of time so as to clarify the above.

The ignition operation should be maintained for at least one second, but preferably at least two seconds so as to ensure that the lamp 12 will ignite reliably.

Immediately after ignition, high-pressure discharge lamps require a high operating voltage of more than 250 V for a short time until the lamp electrodes have heated up sufficiently for entering the arc mode. In the normal case, however, the circuit described is capable of generating a lamp voltage of at most half the operating voltage U₊, i.e. typically 200 V for an operating voltage of at most 400 V.

A resonance effect may be utilized again for artificially raising the operating voltage. The resonant circuit formed by the coil L_{ign}, and the capacitor C_{ign} is not eligible for this, because its loading capacity is insufficient if it was suitably dimensioned. The arrangement of the coil Tr_{filt} and the capacitor C_{filt}, however, also forms a resonant circuit which is usually operated above its resonance frequency.

The process controller 202 first achieves for the transition phase that the multiplexer 201 uses the output signals of the EXCLUSIVE-OR members 226, 227 as its input signals instead of the complementary output signals of the first frequency generator 211. In addition, the frequency F2 of the second frequency generator 221 is lowered in the direction of the resonance frequency of the resonant circuit Tr_{filt}, C_{filt} by the process controller 202. The triggering procedure of the transistors T₁, T₂ corresponds to the triggering in normal operation to be described further below during this. The reduced frequency F2 results in a voltage rise of medium frequency which generates a sufficient current through the lamp 12 for heating up the electrodes. At the same time, a strong rise of the lamp current is prevented by the frequency and by the inductance of the coil Tr_{filt}. The lamp voltage gradient Uₗₐₘₚ and the gradient of the output voltage of the half bridge U₁ during such a heating-up phase are plotted in FIG. 4 in volts as a function of time.

After the lamp 12 has ignited and its electrodes have become sufficiently heated, the electronic circuit of FIG. 1 may now take over normal operation. For this purpose, the frequency F2 of the frequency generator 221 is returned to its original value.

Normally, it may now first be assumed that the two capacitors C_{DC1} and C_{DC2} have become charged such that the voltage at their junction point amounts to approximately half the operating voltage U₊ of the circuit. A low-frequency alternating current is now to be generated in the lamp 12 by means of a suitable control of the transistors T₁, T₂, often with a square-wave characteristic.

This control by the control circuit 14 will now be explained with reference to the example of the positive half wave of the lamp current iₗₐₘₚ. The starting position assumed here is that the current iₗₐₘₚ and the voltage across the lamp are positive, and that the current i₁ in the coil Tr_{filt} is also positive. The voltage across the capacitor C_{filt} is approximately the sum of half the operating voltage U₊ and the positive lamp voltage. The flipflop 222 is not set. Since the polarity signal of the waveform generator 224 indicates that the lamp current should be instantaneously positive, the EXCLUSIVE-OR members 226, 227 invert the complementary outputs Q, /Q of the flipflop 222. As a result, the transistor T₁ is switched on and the transistor T₂ is switched off.

Now the flipflop 222 is set by a pulse from the second frequency generator 221. A “1” is generated thereby at the Q output of the flipflop 222, which switches off the transistor T₁ after inversion by the associated EXCLUSIVE-OR member 226 without further delay. A “0” is generated at the /Q output of the flipflop 222, which switches on the transistor T₂ after inversion and after a delay time DT has elapsed. The delay time DT serves to exclude that the two transistors T₁, T₂ of the half bridge can be conducting at the same time.

The voltage at the output 11 of the half bridge is now 0 V. This means that the positive voltage i₁ in the coil Tr_{filt} becomes smaller quickly because the right-hand terminal is at a high potential. As was noted above, this high potential amounts to approximately the sum of half the operating voltage U₊ and the lamp voltage. When the reference value supplied by the waveform generator 224 is undershot by the measured value of the current i₁ at the comparator 223, said comparator 223 will deliver a low-level signal “0” at its output. This signal is inverted by the EXCLUSIVE-OR member 225 because of the still high-level polarity signal of the waveform generator 224 and resets the flipflop 222. This switches off the transistor T₂ again and switches on the transistor T₁ after a delay time DT.

The operating voltage U₊, which is higher than the voltage across the capacitor C_{filt}, is applied to the output of the half bridge 11 again, so that the current i₁ in the coil Tr_{filt} rises again. This state is maintained up to the next pulse of the frequency generator 221. Since no low-frequency current component can flow through the capacitor C_{filt}, the low-frequency component enters the capacitors C_{DC1} and C_{DC2} via the coil L_{ign} through the lamp 12. The capacitor C_{ign} has such a small value that it is irrelevant for the lamp current Iₗₐₘₚ when the lamp 12 has been ignited.

FIG. 5 plots the current i₁ through the coil Tr_{filt} and the lamp current iₗₐₘₚ in amps over two cycles of the signal F2 of the frequency generator 221 during the positive half wave of the lamp current. The broken line in addition represents a reference current i_{ref} which is the reference value of the waveform generator 224 for the positive half wave of the lamp current.

It is apparent that a rise in the reference value of the waveform generator 224 will move the entire current gradient in parallel along with it, i.e. also the average value of the lamp current iₗₐₘₚ will rise to exactly the same degree. This thus provides a simple possibility of adjusting the value of the lamp current iₗₐₘₚ. FIG. 5 also shows that the current i₁ in the coil Tr_{filt} changes its sign also with a positive lamp current iₗₐₘₚ in spite of a superimposed DC component. This renders it possible to use the so-termed zero-voltage switching during normal operation as well as during transitional operation.

Since the dominant frequency component at the output of the half bridge is the frequency F2 corresponding to the blocking frequency, this frequency component is extinguished at the central tap of the coil Tr_{filt}. The voltage across the capacitor C_{filt} cannot now be regarded as constant any more, but it is subject to substantial fluctuations. These fluctuations are reflected in FIG. 5 as a deviation of the current gradient iₗₐₘₚ from a constant gradient.

The lamp current iₗₐₘₚ and the lamp voltage are negative during the negative half wave. The voltage across the capacitor C_{filt} now is the sum of half the operating voltage U₊ and the negative value of the lamp voltage. The waveform generator 224 now supplies a “0” polarity signal in accordance with the envisaged lamp current gradient. This means that the EXCLUSIVE-OR members 225, 226, 227 have no influence, they merely pass on the respective signals applied to them apart from the polarity signal at their outputs again. It is first assumed that the current i₁ in the coil Tr_{filt} is negative. The pulse of the frequency generator 221 again sets the flipflop 222, but now the transistor T₁ is switched on and the transistor T₂ is switched off after a delay time DT thereby this time. The operating voltage U₊ of the circuit is subsequently present at the output 11 of the half bridge. This voltage is substantially higher than the voltage across the capacitor C_{filt}, so that the current i₁ in the coil Tr_{filt} rises quickly. When the reference value supplied by the waveform generator 224 is exceeded, the comparator 223 generates a “1” at its output, whereby the flipflop 222 is reset again. This switches off the transistor T₁ and switches on the transistor T₂ after a delay time DT. The voltage at the output 11 of the half bridge then is 0 V. Since the voltage across the capacitor C_{filt} is greater than zero, the current i₁ in the coil Tr_{filt} is built up again.

FIGS. 6 to 8 show possible modifications of the circuit of FIG. 1, which modified circuits, however, perform the same basic functions as the circuit of FIG. 1. The fundamental construction is the same as in FIG. 1 each time, and corresponding components have been given the same reference symbols, so that only the respective differences need be described below. The control circuit not shown in FIGS. 6 to 8 may also be the same as the control circuit of the first embodiment.

In the first modification shown in FIG. 6, the third, outermost tap of the coil Tr_{filt} is additionally connected to the operating voltage U₊ of the circuit via a capacitor C_{filtb}. The capacitor denoted C_{filt} of FIG. 1 is denoted C_{filta} in FIG. 6 for better distinguishability. Similarly, the second terminal of the coil L_{ign} is additionally connected to the operating voltage U₊ of the circuit via a capacitor C_{ignb}. The capacitor denoted C_{ign} in FIG. 1 is denoted C_{igna} in FIG. 6.

In the second modification shown in FIG. 7, the capacitors C_{filt} and C_{ign} are not directly connected to the reference potential of the circuit, but are connected to the junction point between the capacitors C_{DC1}, C_{DC2}. It is clear from this that the coils may also be indirectly connected to the reference potential of the circuit via the respective capacitor designed for forming a resonant circuit.

In the third modification shown in FIG. 8, an additional capacitor C_{dvdtb}, C_{dvdta} is connected in parallel to each transistor T₁, T₂, respectively. The capacitors C_{dvdtb}, C_{dvdta} here serve to limit the speed of the voltage rise during switching over of the transistors T₁, T₂ of the half bridge. Alternatively, only one of the additional capacitors may be used. The capacitors for limiting the speed of the voltage rise in the embodiment of FIG. 8 lead to particularly low switching losses in the zero-voltage switching mentioned with reference to FIG. 5.

The description of the manner of operation of the circuit of FIG. 1 is valid in a corresponding manner for these as well as other modifications of the circuit of FIG. 1 in which the capacitors are arranged in an equivalent high-frequency manner with respect to the output current of the half bridge and the lamp current. Similarly, some of the components may be connected, for example, in series with additional resistors.

The embodiments described represent only a few examples from among a plurality of possible implementations of the invention.

1. An electronic circuit for supplying a high-pressure discharge arc lamp (12), which circuit comprises a half bridge comprising at least one controllable switching element (T₁, T₂) in each of its bridge branches for providing an alternating current, and at least two coils (L_{ign}, Tr_{filt}), four capacitors (C_{ign}, C_{DC2}, C_{DC1}, C_{filt}, C_{igna}, C_{filta}), and two connection terminals for a high-pressure discharge arc lamp (12), which half bridge (T₁, T₂) is connected between a connection terminal of the circuit for providing an operating potential (U₊) and a connection terminal of the circuit for providing a reference potential (10), while a first connection terminal of the first coil (L_{ign}) is connected to the first connection terminal for a high-pressure discharge arc lamp (12) and to the connection terminal for the reference potential (10) at least via the first capacitor (C_{ign}, C_{igna}), and the second connection terminal for a high-pressure discharge arc lamp (12) is connected to the connection terminal for the operating potential (U₊) at least via the second capacitor (C_{DC2}) as well as to the connection terminal for the reference potential (10) at least via the third capacitor (C_{DC1}),
characterized in that
the second coil (Tr_{filt}) has at least three taps, of which a first, outer tap is connected to the output (11) of the half bridge (T₁, T₂), of which a second, central tap is connected to the second connection terminal of the first coil (L_{ign}), and of which a third, outer tap is connected to the connection terminal for the reference potential (10) at least via the fourth capacitor (C_{filt}, C_{filta}).

2. An electronic circuit as claimed in claim 1, characterized in that the first capacitor and the fourth capacitor (C_{ign}, C_{filt}, C_{igna}, C_{filta}) are each directly connected to the connection terminal for the reference potential.

3. An electronic circuit as claimed in claim 1, characterized in that the first capacitor and the fourth capacitor (C_{ign}, C_{filt}) are each connected to the connection terminal for the reference potential via the third capacitor (C_{DC1}) and are each connected to the connection terminal for the operating potential (U₊) via the second capacitor (C_{DC2}).

4. An electronic circuit as claimed in claim 1, characterized in that the first connection terminal of the first coil (L_{ign}) is additionally connected to the connection terminal for the operating potential (U₊) via a fifth capacitor (C_{ignb}), and/or in that the third, outer tap of the second coil (Tr_{filt}) is additionally connected to the connection terminal for the operating potential (U₊) via a sixth capacitor (C_{filtb}).

5. An electronic circuit as claimed in claim 1, characterized in that the output of the half bridge (T₁, T₂) is additionally connected to the connection terminal for the reference potential via at least one further capacitor (C_{dvdta}).

6. An electronic circuit as claimed in claim 1, characterized in that the output of the half bridge (T₁, T₂) is additionally connected to the connection terminal for the operating potential (U₊) via at least one further capacitor (C_{dvdtb}).

7. An electronic circuit as claimed in claim 1, characterized in that the arrangement consisting of the second coil (Tr_{filt}) and the fourth capacitor (C_{filt}) forms a blocking filter for the central tap of the second coil (Tr_{filt}) at a switching frequency with which the controllable switching elements (T₁, T₂) of the half bridge are preferably switched in normal operation.

8. An electronic circuit as claimed in claim 1, characterized in that the resonance frequency of a resonant circuit comprising the first coil (L_{ign}) and the first capacitor (C_{ign}) is higher than a frequency at which the arrangement of the second coil (Tr_{filt}) and the fourth capacitor (C_{filt}) forms a blocking filter for the central tap of the second coil (Tr_{filt}).

9. An electronic circuit as claimed in claim 8, characterized in that the resonance frequency of a resonant circuit comprising the first coil (L_{ign}) and the first capacitor (C_{ign}) is an odd multiple of the frequency at which the arrangement of the second coil (Tr_{filt}) and the fourth capacitor (C_{filt}) forms a blocking filter for the central tap of the second coil (Tr_{filt}).

10. An electronic circuit as claimed in claim 1, characterized by a control circuit (14) for controlling the switching elements (T₁, T₂) of the half bridge, and by a current sensor arranged between the output (11) of the half bridge and the second coil (Tr_{filt}) for measuring the current (i₁) through the second coil (Tr_{filt}), which sensor passes on the measured data to the control circuit (14), which control circuit (14) controls the switching elements (T₁, T₂) in dependence on the measurement results of the current sensor (13).

11. An electronic circuit as claimed in claim 10, characterized in that the control circuit (14) comprises:
a first frequency generator (211) for providing complementary pulses for an ignition operation of the electronic circuit,
a second frequency generator (221) for providing trigger pulses for a normal operation of the electronic circuit,
a waveform generator (224) for providing a current reference signal and a lamp current direction in accordance with a desired lamp current gradient,
a comparator (223) for comparing the measurement results of the current sensor (13) with the current reference signal from the waveform generator (224), such that the output of the comparator (223) is inverted in the case of a desired positive lamp current, and
a flipflop (222) with two complementary outputs (Q, /Q) which is set by the trigger pulses of the second frequency generator (221), which is reset by a high-level output signal of the comparator (223), possibly after an inversion, and whose complementary output signals are inverted in the case of a desired positive lamp current, and
a process controller (202) for switching over between an ignition operation and a normal operation, which controller for the purpose of normal operation supplies one of the—possibly inverted—complementary output signals of the flipflop (222) to one of the switching elements (T₁, T₂) of the half bridge so as to control the latter, such that the switching element (T₂) at the side of the reference potential is switched on and the switching element (T₁) at the side of the operating voltage is switched off the moment the second frequency generator (221) generates a trigger pulse if a positive lamp current is desired, and the switching element (T₂) at the reference potential side is switched off and the switching element (T₁) at the operating voltage side is switched on when the measured value of the current sensor (13) undershoots the reference value of the waveform generator (224), whereas for a desired negative lamp current the switching element (T₁) at the operating voltage side is switched on and the switching element (T₂) at the reference potential side is switched off the moment the second frequency generator (221) generates a trigger pulse, and the switching element (T₁) at the operating voltage side is switched off and the switching element (T₂) at the reference potential side is switched on when the measured value of the current sensor (13) overshoots the reference value of the waveform generator (224).

12. An electronic circuit as claimed in claim 11, characterized in that the first frequency generator (211) makes available the complementary pulses at a frequency which corresponds to the resonance frequency of the serial tuned circuit comprising the first coil (L_{ign}) and the first capacitor (C_{ign}), and in that the second frequency generator (221) for the purpose of a normal operation of the electronic circuit makes available the trigger pulses with a frequency which corresponds to the frequency at which the arrangement of the second coil (Tr_{filt}) and the fourth capacitor (C_{filt}) forms a blocking filter for the central tap of the second coil (Tr_{filt}).

13. An electronic circuit as claimed in claim 11, characterized in that the process controller (202) feeds the complementary pulses provided by the first frequency generator (211) to the switching elements (T₁, T₂) of the half bridge to control the latter during an ignition phase.

14. An electronic circuit as claimed in claim 13, characterized in that the process controller (202) after the end of the ignition phase switches over the frequency of the trigger pulses provided by the second frequency generator (221) for a short time to a frequency below the frequency at which the arrangement of the second coil (Tr_{filt}) and the fourth capacitor (C_{filt}) forms a blocking filter for the central tap of the second coil (Tr_{filt}).

15. A method of operating a high-pressure lamp by means of an electronic circuit as claimed in claim 1, characterized in that the switching elements (T₁, T₂) of the half bridge are controlled such that a substantially zero-voltage switching takes place each time.

16. A method of operating a high-pressure lamp by means of an electronic circuit as claimed in claim 1, characterized in that, for the purpose of igniting a high-pressure discharge lamp (12) connected between the connection terminals for a high-pressure discharge lamp, the switching elements (T₁, T₂) of the half bridge are switched during an ignition phase substantially exactly at the resonance frequency or an odd multiple of the resonance frequency of the resonant circuit consisting of the first coil (L_{ign}) and the fourth capacitor (C_{ign}).

17. A lighting system comprising an electronic circuit as claimed in claim 1 and a high-pressure gas discharge lamp (12) which is connected between the two connection terminals of the electronic circuit designed for a high-pressure discharge arc lamp.

18. A device for the display of still or moving images utilizing an electronic circuit as claimed in claim 1.
